(19) United States
(12) Patent Application Publication
(10) Pub. No.: US 2025/0192884 A1
(43) Pub. Date: Jun. 12, 2025

(54) CONTROLLER, TRAINING COST REDUCTION METHOD, AND NON-TRANSITORY COMPUTER-READABLE MEDIUM

(71) Applicant: NEC Corporation, Tokyo (JP)

(72) Inventor: Kenji FUKUI, Tokyo (JP)

(73) Assignee: NEC Corporation, Tokyo (JP)

(21) Appl. No.: 18/938,367

(22) Filed: Nov. 6, 2024

(30) Foreign Application Priority Data
Dec. 11, 2023 (JP) 2023-208343

(51) Int. Cl. H04B 10/079; H04B 10/61; H04W 24/02

(52) U.S. Cl. CPC H04B 10/07955; H04B 10/6165; H04W 24/02

(57) ABSTRACT

A controller: collects PM data of each of a plurality of optical transmission apparatuses provided in an optical transmission network; learns, with a plurality of AI models provided for each of the plurality of optical transmission apparatuses, a variation in time series of the PM data of the optical transmission apparatus; stores an average value and an allowable error of the PM data of the optical transmission apparatus in a database for each of the plurality of optical transmission apparatuses; detects an abnormality within the optical transmission network by using the plurality of AI models; and, in a case where there is an optical transmission apparatus in which the PM data after restoration from the abnormality are outside a threshold range, which is derived from the average value and the allowable error, determines that an AI model of the relevant optical transmission apparatus needs retraining.

### INCORPORATION BY REFERENCE

This application is based upon and claims the benefit of priority from Japanese patent application No. 2023-208343, filed on Dec. 11, 2023, the disclosure of which is incorporated herein in its entirety by reference.

### TECHNICAL FIELD

The present disclosure relates to a controller, a training cost reduction method, and a non-transitory computer-readable medium.

### BACKGROUND ART

A communication service provider (CSP), such as a communication carrier, performs operation and maintenance work for networks being managed. However, the larger and more complex the network is, the more frequently the network changes due to construction or failure. Therefore, it is difficult to automate the operation and maintenance of the network, and so far, the operation and maintenance of the network have been performed manually.

However, in a case where the operation and maintenance of the network are performed manually, tasks that involve a plurality of departments managing the network, such as determination of a degree of influence on a service at a time of occurrence of a failure and identification of a portion being a cause of the failure, occur on demand. This contributes to an increase in operating expense (OPEX).

Meanwhile, in recent years, a main business of CSP is shifting from telecommunications business to non-telecommunications business, and it is expected that capital investment in the telecommunications business is restrained in the future. Therefore, reduction of capital expenditure (CAPEX) and OPEX in the telecommunications business is required. Further, a population decline is expected to lead to a shortage of specialist personnel. Therefore, there is also a need to automatically perform tasks that have been performed manually.

In view of the above-described background, automation of operation and maintenance work for a network is required. The operation and maintenance of the network is mainly performed by a controller that manages the network and apparatuses provided in the network. The controller manages each piece of apparatus information (configuration information, fault information, performance monitoring (PM) information, and the like) and network information (topology information, logical path information, service information, and the like). The controller may be manually operated by an operator, or some of the operations thereof may be automated.

There are two main approaches to network operation and maintenance automation. One approach is rule-based automation, and another approach is automation utilizing artificial intelligence (AI).

The present disclosure focuses on automation utilizing AI that can be applied to various networks. Note that, the present disclosure is based on a premise that a target network is an optical transmission network and a target apparatus is an optical transmission apparatus.

Herein, as a technique for automating the operation and maintenance of the optical transmission network by utilizing AI, for example, a technique disclosed in Japanese Unexamined Patent Application Publication No. 2017-108220 is exemplified.

### SUMMARY

Incidentally, in an optical transmission network, in a case where an abnormality of a physical port of an optical transmission apparatus or an abnormality of an optical fiber between the optical transmission apparatuses occurs, PM data representing an optical power level (OP: optical power) of an optical signal of each of the optical transmission apparatuses vary.

Therefore, in the controller, an AI model learns (performs machine learning of) the time-series variation of the PM data in advance by using the PM data as learning data. In a case where an abnormality occurs, the controller detects the abnormality by detecting the variation of the PM data caused by occurrence of the abnormality by using the AI model.

However, there is a possibility that the PM data vary after restoration from the abnormality due to a slight change in state of the optical transmission apparatus or the optical fiber according to how the restoration is performed. In such a case, the PM data after the restoration from the abnormality become PM data having a pattern different from that of the PM data being used as the learning data in the AI model before occurrence of the abnormality, and therefore, there is a possibility that retraining of the AI model is necessary.

Furthermore, in a case where influence of the abnormality and the restoration is large, an optical transmission apparatus in a subsequent stage of a location where the abnormality has occurred may be affected by the influence (variation of the PM data), and the AI model of the affected optical transmission apparatus may also need to be retrained.

However, in a case where all the AI models of the optical transmission apparatuses affected by the abnormality and the restoration are retrained, there arises a problem of an increase in retraining cost of the AI model.

In view of the above-described problem, an example object of the present disclosure is to provide a controller, a training cost reduction method, and a non-transitory computer-readable medium that are capable of reducing a retraining cost of an AI model after restoration from an abnormality.

In a first example aspect, a controller includes:
at least one memory storing instructions;
a first processor configured to execute the instructions and collect performance monitoring (PM) data representing an optical power level of an optical signal of each of a plurality of optical transmission apparatuses provided in an optical transmission network;
a plurality of artificial intelligence (AI) models, being provided for each of the plurality of optical transmission apparatuses provided in the optical transmission network, configured to learn a variation in time series of the PM data of the optical transmission apparatus by using the PM data of the optical transmission apparatus as learning data;
a database configured to hold an average value and an allowable error of the PM data of the optical transmission apparatus for each of the plurality of optical transmission apparatuses;
a second processor configured to execute the instructions and detect an abnormality within the optical transmission network by using the plurality of AI models; and
a third processor configured to execute the instructions and, in a case where there is an optical transmission apparatus in which the PM data after restoration from the abnormality are outside a threshold range, which is derived from the average value and the allowable error, determine that an AI model of the relevant optical transmission apparatus needs retraining.

In a second example aspect, a training cost reduction method is a training cost reduction method to be executed by a controller and includes:
collecting performance monitoring (PM) data representing an optical power level of an optical signal of each of a plurality of optical transmission apparatuses provided in an optical transmission network;
learning, with a plurality of artificial intelligence (AI) models provided for each of the plurality of optical transmission apparatuses, a variation in time series of the PM data of the optical transmission apparatus by using the PM data of the optical transmission apparatus as learning data;
storing an average value and an allowable error of the PM data of the optical transmission apparatus in a database for each of the plurality of optical transmission apparatuses;
detecting an abnormality within the optical transmission network by using the plurality of AI models; and,
in a case where there is an optical transmission apparatus in which the PM data after restoration from the abnormality are outside a threshold range, which is derived from the average value and the allowable error, determining that an AI model of the relevant optical transmission apparatus needs retraining.

In a third example aspect, a non-transitory computer-readable medium stores a program for causing a computer to execute:
a procedure of collecting performance monitoring (PM) data representing an optical power level of an optical signal of each of a plurality of optical transmission apparatuses provided in an optical transmission network;
a procedure of learning, with a plurality of artificial intelligence (AI) models provided for each of the plurality of optical transmission apparatuses, a variation in time series of the PM data of the optical transmission apparatus by using the PM data of the optical transmission apparatus as learning data;
a procedure of storing an average value and an allowable error of the PM data of the optical transmission apparatus in a database for each of the plurality of optical transmission apparatuses;
a procedure of detecting an abnormality within the optical transmission network by using the plurality of AI models; and
a procedure of, in a case where there is an optical transmission apparatus in which the PM data after restoration from the abnormality are outside a threshold range, which is derived from the average value and the allowable error, determining that an AI model of the relevant optical transmission apparatus needs retraining.

### BRIEF DESCRIPTION OF DRAWINGS

The above and other aspects, features, and advantages of the present disclosure will become more apparent from the following description of certain example embodiments in a case where taken in conjunction with the accompanying drawings, in which:

FIG. 1 is a diagram illustrating a configuration example of a network system according to the present disclosure;

FIG. 2 is a diagram illustrating a configuration example of a controller according to the present disclosure;

FIG. 3 is a diagram illustrating an example of PM information held by the controller according to the present disclosure;

FIG. 4 is a diagram illustrating a configuration example of an optical transmission apparatus according to the present disclosure;

FIG. 5 is a diagram describing an operation example of a case where PM data are being collected in the network system according to the present disclosure;

FIG. 6 is a diagram describing an example of PM data in a case where an abnormality occurs in the network system according to the present disclosure;

FIG. 7 is a sequence diagram describing an operation example after restoration from the abnormality in the case where the abnormality in FIG. 6 has occurred, in the network system according to the present disclosure;

FIG. 8 is a diagram describing an example of PM data in a case where an abnormality occurs in the network system according to the present disclosure;

FIG. 9 is a sequence diagram describing an operation example after restoration from the abnormality in the case where the abnormality in FIG. 8 has occurred, in the network system according to the present disclosure;

FIG. 10 is a diagram illustrating a configuration example of the controller according to the present disclosure; and

FIG. 11 is a block diagram illustrating a hardware configuration example of a computer that implements the controller according to the present disclosure.

### EXAMPLE EMBODIMENT

Hereinafter, example embodiments of the present disclosure is described with reference to the drawings. Note that the following description and the drawings are omitted and simplified as appropriate for clarity of description. In the following drawings, the same element is denoted by the same reference numeral, and redundant description is omitted as necessary. Further, specific numerical values and the like indicated below are merely examples for facilitating understanding of the present disclosure, and are not limited thereto.

### First Example Embodiment

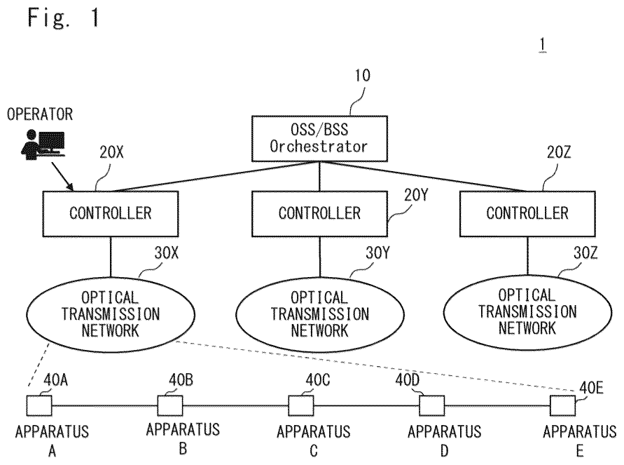

First, a configuration example of a network system 1 is described with reference to FIG. 1.

As illustrated in FIG. 1, the network system 1 includes an operation support system (OSS)/business support system (BSS) orchestrator 10, controllers 20X, 20Y, and 20Z, optical transmission networks 30X, 30Y, and 30Z, and optical transmission apparatuses (for example, optical transmission apparatuses 40A, 40B, 40C, 40D, and 40E provided in the optical transmission network 30X) provided in the optical transmission networks 30X, 30Y, and 30Z.

In FIG. 1 and the drawings described below, the optical transmission apparatuses 40A, 40B, 40C, 40D, and 40E are illustrated as apparatuses A, B, C, D, and E as appropriate.

In the following description, the controller 20X, 20Y, and 20Z are referred to as a controller 20 in a case where they are not specified. Similarly, the optical transmission networks 30X, 30Y, and 30Z are referred to as an optical transmission network 30, and the optical transmission apparatuses 40A, 40B, 40C, 40D, and 40E are referred to as an optical transmission apparatus 40.

Although three controllers 20 and three optical transmission networks 30 are illustrated in FIG. 1, this number is one example and is not limited thereto. Further, in FIG. 1 and the drawings described hereinafter, five optical transmission apparatuses 40A, 40B, 40C, 40D, and 40E are illustrated as the optical transmission apparatus 40 provided in the optical transmission network 30X, but this number is one example and is not limited thereto.

The optical transmission network 30 is connected to the controller 20. The controller 20 manages network information (topology information, logical path information, service information, and the like) regarding the connected optical transmission network 30, and manages apparatus information (configuration information, fault information, PM information, and the like) regarding each of the optical transmission apparatuses 40 provided in the connected optical transmission network 30. In addition, some operations of the controller 20 may be automated and the remaining operations may be performed manually by an operator, or all operations may be automated. In the present disclosure, it is assumed that at least an operation of an autonomous control function unit 25 described later is automated.

Hereinafter, a configuration example of the controller 20 and the optical transmission apparatus 40 is described.

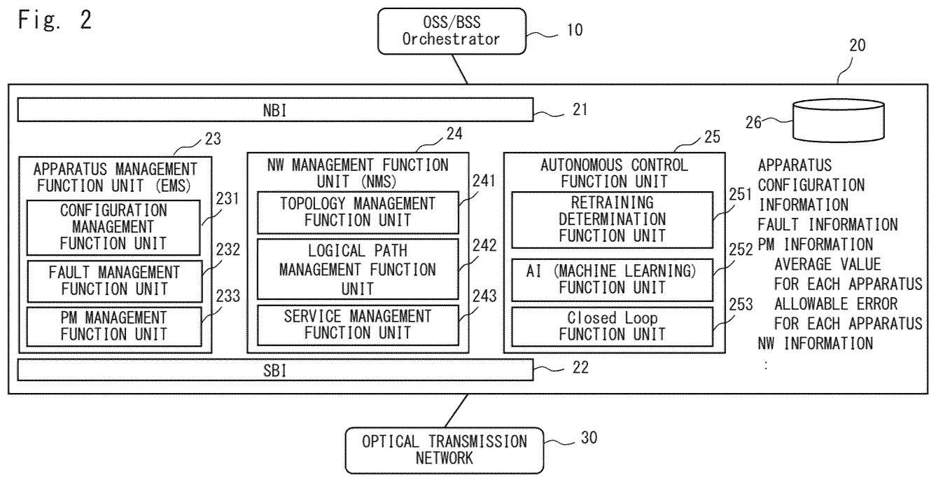

First, a configuration example of the controller 20 is described with reference to FIG. 2.

As illustrated in FIG. 2, the controller 20 includes a northbound interface (NBI) 21, a southbound interface (SBI) 22, an apparatus management function unit 23, a network (NW) management function unit 24, the autonomous control function unit 25, and a database 26.

The apparatus management function unit 23 includes a configuration management function unit 231, a fault management function unit 232, and a PM management function unit 233. The apparatus management function unit 23 is implemented by, for example, an element management system (EMS).

The configuration management function unit 231 collects configuration information regarding each of the optical transmission apparatuses 40 provided in the connected optical transmission network 30, and manages the collected configuration information.

The fault management function unit 232 collects fault information regarding each of the optical transmission apparatuses 40 provided in the connected optical transmission network 30, and manages the collected fault information.

The PM management function unit 233 collects PM data of each of the optical transmission apparatuses 40 provided in the connected optical transmission network 30, and manages the collected PM data as PM information. As described above, the PM data are data representing an optical power level of an optical signal.

The network (NW) management function unit 24 includes a topology management function unit 241, a logical path management function unit 242, and a service management function unit 243. The NW management function unit 24 is implemented by, for example, a network management system (NMS).

The topology management function unit 241 collects topology information regarding the connected optical transmission network 30 and manages the collected topology information.

The logical path management function unit 242 collects logical path information regarding the connected optical transmission network 30 and manages the collected logical path information.

The service management function unit 243 collects service information regarding the connected optical transmission network 30 and manages the collected service information.

Note that, the controller 20 includes both the apparatus management function unit 23 and the NW management function unit 24, but is not limited thereto. The controller 20 may include only the apparatus management function unit 23, and the NW management function unit 24 may be provided in another apparatus.

The autonomous control function unit 25 includes a retraining determination function unit 251, an AI (machine learning) function unit 252, and a closed loop control unit 253.

The AI function unit 252 performs machine learning on time-series variations of the PM data by using the PM data as learning data.

In the present disclosure, an object of machine learning is to perform a predictor detection of detecting an abnormal behavior (abnormality of the physical port of the optical transmission apparatus 40 or abnormality of the optical fiber) before a failure of the optical transmission apparatus 40 or a fault of the optical transmission apparatus 40 or the optical fiber occurs in the optical transmission network 30.

Further, it is conceivable that the AI model of the machine learning is generated in various units such as on an optical transmission apparatus 40 basis, a path basis, and an optical transmission network 30 basis. Herein, the path is a route constructed to pass an optical signal within the optical transmission network 30, and is a logical route that crosses the plurality of optical transmission apparatuses 40. The path between the optical transmission apparatuses 40 is physically constructed in such a way as to pass through the optical fibers connecting the optical transmission apparatuses 40. In addition, in the path between the optical transmission apparatuses 40, optical signals of a plurality of wavelengths are transmitted by a single optical fiber by an optical wavelength multiplexing method represented by wavelength division multiplexing (WDM).

However, if a single AI model is generated for the plurality of optical transmission networks 30 as a whole or an AI model is generated on an optical transmission networks 30 basis, retraining of the AI model is required even if there is a slight change in the optical transmission network 30, and therefore, the retraining is frequently required, and the AI model is not stable.

In addition, if an AI model is generated on a path basis, the number of AI models increases linearly with respect to a linear increase in the paths, and therefore there is a concern that computing resources required for machine learning increase.

Therefore, in the present disclosure, it is assumed that an AI model is generated on an optical transmission apparatus 40 basis.

More specifically, the present disclosure assumes that AI models are generated for each of the optical power transmitter (OPT) side and the optical power receiver (OPR) side of the optical transmission apparatus 40 in units of the optical transmission apparatus 40.

Therefore, the PM management function unit 233 periodically collects the PM data on the OPT side and the OPR side of each of the optical transmission apparatuses 40 from each of the optical transmission apparatuses 40 provided in the connected optical transmission network 30.

In addition, the AI function unit 252 generates an AI model in which time-series variation of the relevant PM data is machine-learned for each of the OPT side and the OPR side of each of the optical transmission apparatuses 40 provided in the connected optical transmission network 30.

Herein, in a case where some kind of abnormality (weak contamination of the physical port, stress on the optical fiber, or the like) occurs in a physical port or optical fiber of the optical transmission apparatus 40 through which a path constructed in the optical transmission network 30 passes, the PM data after the restoration from the abnormality may be different from the PM data used as the learning data in the AI model until then. In such a case, it is basically necessary to retrain the AI model. However, in a case where all AI models having different PM data before and after the restoration from the abnormality are retrained, there arises a problem of an increase in the retraining cost of the AI models.

Therefore, in the present disclosure, the retraining determination function unit 251 determines whether the retraining of the AI model is necessary for each of the OPT side and the OPR side of each of the optical transmission apparatuses 40 after the restoration from the abnormality. An AI model for which the retraining determination function unit 251 determined that retraining is unnecessary is not retrained. As a result, the number of AI models to be retrained is reduced, and therefore the retraining cost of the AI models is reduced. Details of the operation of the retraining determination function unit 251 is described later.

The closed loop control unit 253 controls the connected optical transmission network 30 and each of the optical transmission apparatuses 40 provided in the connected optical transmission network 30 by using the AI model generated by the AI function unit 252 and the determination result determined by the retraining determination function unit 251.

The database 26 holds configuration information, fault information, and PM information regarding each of the optical transmission apparatuses 40 provided in the connected optical transmission network 30 and managed by the configuration management function unit 231, the fault management function unit 232, and the PM management function unit 233.

The database 26 further holds topology information, logical path information, and service information regarding the connected optical transmission network 30 and managed by the topology management function unit 241, the logical path management function unit 242, and the service management function unit 243.

Herein, as the PM information, the database 26 holds an average value Av and an allowable error R of relevant PM data for each of the OPT side and the OPR side of each of the optical transmission apparatuses 40 provided in the connected optical transmission network 30.

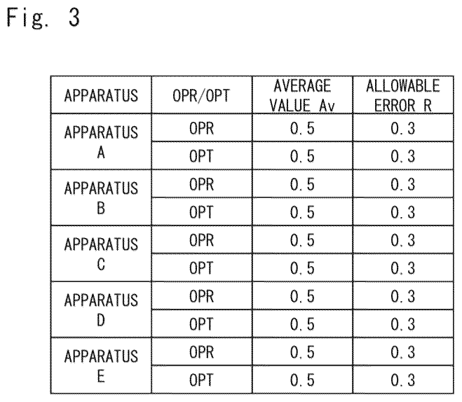

For example, as illustrated in FIG. 3, the database 26 in the controller 20X holds the average value Av and the allowable error R of the relevant PM data for each of the OPT side and the OPR side of each of the optical transmission apparatuses 40A, 40B, 40C, 40D, and 40E provided in the optical transmission network 30X. In the example of FIG. 3, for the sake of simplification of the description, all of the average values Av and the allowable errors R on the OPT side and the OPR side of the optical transmission apparatuses 40A, 40B, 40C, 40D, and 40E are set to the same value. However, this value is merely an example, and is not limited thereto, and may be different values from one another.

After the restoration from the abnormality, the retraining determination function unit 251 determines whether the retraining of the AI model is necessary for each of the OPT side and the OPR side of each of the optical transmission apparatuses 40, by using mathematical formula 1 described below and using the value Value of the PM data after the restoration from the abnormality and the average value Av and the allowable error R of the PM data held in the database 26.

$$case apparatus name \text{:} if ( value > Av + R ) \qquad [ Mathematical formula 1 ]$$

$$OR$$

$$( value < Av - R )$$

$$do AI model retraining$$

For example, in the example of FIG. 3, the average value Av of the PM data on the OPR side of the optical transmission apparatus 40C is 0.5, and the allowable error R is 0.3. Therefore, the retraining determination function unit 251 of the controller 20X determines that the retraining of the AI model on the OPR side of the optical transmission apparatus 40C is necessary if the value Value of the PM data after the restoration from the abnormality on the OPR side of the optical transmission apparatus 40C is larger than 0.8 (=0.5+0.3) or smaller than 0.2 (=0.5−0.3).

In other words, the retraining determination function unit 251 determines that the retraining of the AI model is necessary if the value Value of the PM data after the restoration from the abnormality deviates from the threshold range of Av−R≤Value≤Av+R (in the example of FIG. 3, the threshold range of 0.2≤Value≤0.8).

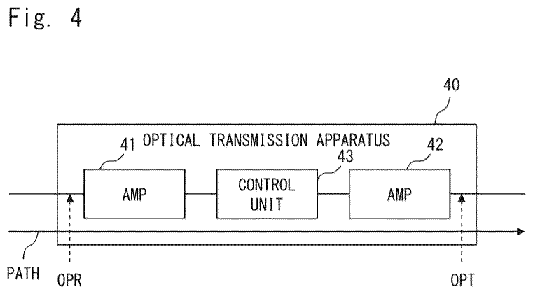

Next, a configuration example of the optical transmission apparatus 40 is described with reference to FIG. 4.

As illustrated in FIG. 4, the optical transmission apparatus 40 includes amplifiers (AMPs) 41 and 42 and a control unit 43.

In the example of FIG. 4, it is assumed that a path for passing an optical signal is constructed from left to right in the drawing. Therefore, the end point of the AMP 41 on the left side in the drawing becomes the OPR, and the end point of the AMP 42 on the right side in the drawing becomes the OPT.

The control unit 43 adjusts the optical power level of an optical signal (optical signal to be transmitted) on the OPT side by a variable optical attenuator (VOA) (not illustrated), based on the optical power level of an optical signal (received optical signal) on the OPR side. The VOA is an optical fiber component that adjusts an attenuation amount of the optical power level of the optical signal.

At this time, the control unit 43 adjusts the optical power level of the optical signal on the OPT side by using the VOA in such a way as to become a target OPT. However, an upper limit of the adjustment amount is set in the VOA, and the control unit 43 cannot perform adjustment exceeding the upper limit of the adjustment amount of the VOA.

Further, the control unit 43 periodically measures the optical power level of the optical signal on the OPR side and the optical power level of the optical signal on the OPT side, and notifies the controller 20 of PM data representing the optical power level on the OPR side and PM data representing the optical power level on the OPT side.

Next, an operation example of the network system 1 is described. Hereinafter, an operation example of the network system 1 is described by taking the controller 20X, the optical transmission network 30X, and the optical transmission apparatuses 40A, 40B, 40C, 40D, and 40E as examples among the constituent elements of the network system 1.

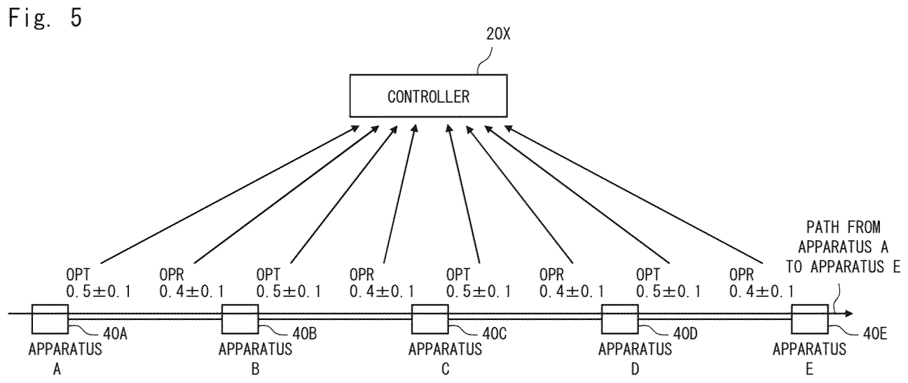

First, an operation example of a case where PM data are collected in the network system 1 is described with reference to FIG. 5. In the example of FIG. 5, it is assumed that a path for passing an optical signal is constructed from the optical transmission apparatus 40A toward the optical transmission apparatus 40E.

As illustrated in FIG. 5, the optical transmission apparatuses 40B, 40C, and 40D, which are intermediate points of the above-described path, periodically notify the controller 20X of the PM data on the OPR side and the PM data on the OPT side. Further, the optical transmission apparatus 40A serving as the starting point of the above-described path periodically notifies the controller 20X of the PM data on the OPT side. Further, the optical transmission apparatus 40E serving as the end point of the above-described path periodically notifies the controller 20X of the PM data on the OPR side.

Herein, the timings at which the optical transmission apparatuses 40A, 40B, 40C, 40D, and 40E periodically notify the PM data are, for example, timings of every 15 minutes or every day. These timings are standardized in the International Telecommunication Union Telecommunication Standardization sector (ITU-T) open reconfigurable optical add/drop multiplexers (ROADM) and the like.

At this time, the optical transmission apparatuses 40A, 40B, 40C, 40D, and 40E, for example, do not directly notify the controller 20X of the 15-minute PM data, but summarize the 15-minute PM data, and notify the controller 20X of the summarized PM data. Therefore, in the example of FIG. 5, for example, the optical transmission apparatus 40A notifies of PM data that is summarized as [0.5±0.1] as the PM data on the OPT side.

A case where the timing for notifying the PM data is every day is handled similarly to the above-described case.

Next, a description is given of an operation example in each of a case 1 and a case 2 in the network system 1, the case 1 being a case where an abnormality in which a slight stress is being applied to the optical fiber due to snowfall or the like occurs, and the case 2 being a case where an abnormality in which the optical fiber is greatly bent occurs.

Hereinafter, for the sake of simplification of the description, it is assumed that the normal range of the PM data on the OPT side and the OPR side of all the optical transmission apparatuses 40A, 40B, 40C, 40D, and 40E is [−2 to +2]. Therefore, in a case where any of the PM data on the OPT side and the OPR side of the optical transmission apparatuses 40A, 40B, 40C, 40D, and 40E deviate from the normal range, the closed loop control unit 253 of the controller 20X determines that a failure of the relevant optical transmission apparatus 40 or a fault in the relevant optical transmission apparatus 40 or fault in an optical fiber connected to the relevant optical transmission apparatus 40 has occurred.

Herein, the abnormalities of the cases 1 and 2 are detected as a predictor of the occurrence of the above-described failure or fault. Therefore, it is assumed that the abnormalities of the cases 1 and 2 occur in a case where the PM data are within the normal range described above. Further, it is assumed that the closed loop control unit 253 of the controller 20X detects the abnormalities of the cases 1 and 2 by using the AI model.

Further, it is assumed that the OPT targets of all the optical transmission apparatuses 40A, 40B, 40C, 40D, and 40E are [0.5] and the adjustment amount upper limit of the VOA is [+0.5].

In the database 26 of the controller 20X, it is assumed that the information illustrated in FIG. 3 is stored as the average value Av and the allowable error R of the PM data on the OPT side and the OPR side of the optical transmission apparatuses 40A, 40B, 40C, 40D, and 40E.

In the optical transmission network 30X, it is assumed that a path for passing an optical signal from the optical transmission apparatus 40A toward the optical transmission apparatus 40E is constructed.

### (1) Case 1

First, the case 1 in which an abnormality that a slight stress is being applied to the optical fiber occurs is described.

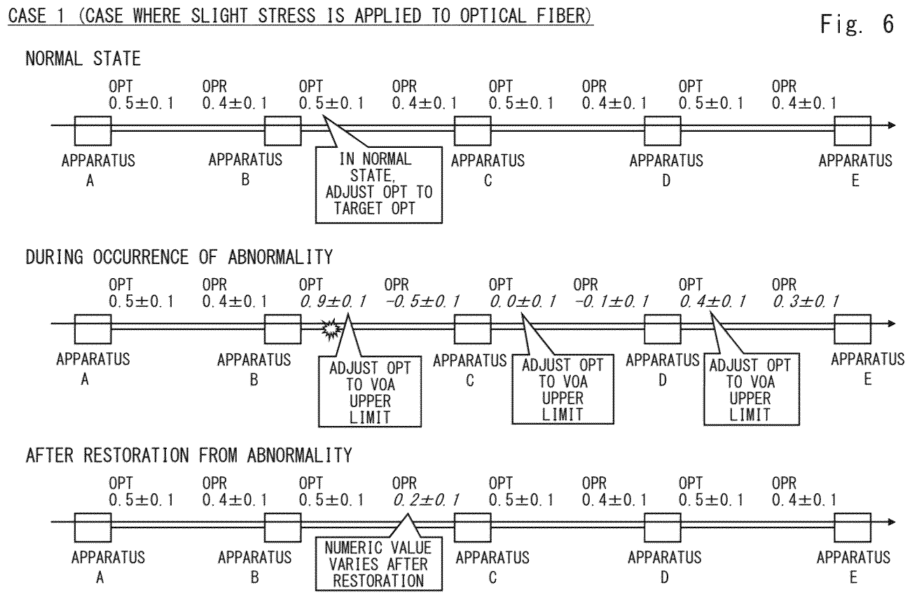

First, with reference to FIG. 6, an example of PM data in a case where an abnormality of the case 1 occurs in the network system 1 is described. As illustrated in FIG. 6, in a normal state, the optical transmission apparatuses 40A, 40B, 40C, 40D, and 40E adjust the optical power level on the OPT side by using the VOA in such a way as to become the target OPT.

Herein, it is assumed that an abnormality occurs in which a slight stress is applied to the optical fiber between the optical transmission apparatuses 40B and 40C.

During the occurrence of the above-described abnormality, the optical power level on the OPR side of the optical transmission apparatus 40C is greatly reduced to [−0.5±0.1].

Then, the optical transmission apparatus 40B detects the drop in the optical power level on the OPR side of the optical transmission apparatus 40C, and increases the optical power level on the OPT side to the adjustment amount upper limit of the VOA to set [0.9±0.1].

The above-described abnormality also affects the optical transmission apparatuses 40D and 40E in the subsequent stage, and the optical power level on the OPR side of the optical transmission apparatuses 40D and 40E is also lowered.

Therefore, the optical transmission apparatuses 40C and 40D also increases the optical power level on the OPT side to the adjustment amount upper limit of the VOA.

Then, it is assumed that the above-described abnormality has been restored.

At this time, the optical power level after the restoration from the abnormality on the OPR side of the optical transmission apparatus 40C is [0.2±0.1], and is varied from the normal power level [0.4±0.1]. On the other hand, the optical power level after the restoration from the abnormality on the OPR side of the other optical transmission apparatuses 40B, 40D, and 40E does not vary from the normal power level.

Next, an operation example after the restoration from the abnormality in the case where the abnormality of the case 1 occurs in the network system 1 is described.

The controller 20X determines whether the retraining of the AI model is necessary for each of the OPT side and the OPR side of each of the optical transmission apparatuses 40A, 40B, 40C, 40D, and 40E after the restoration from the abnormality of the case 1.

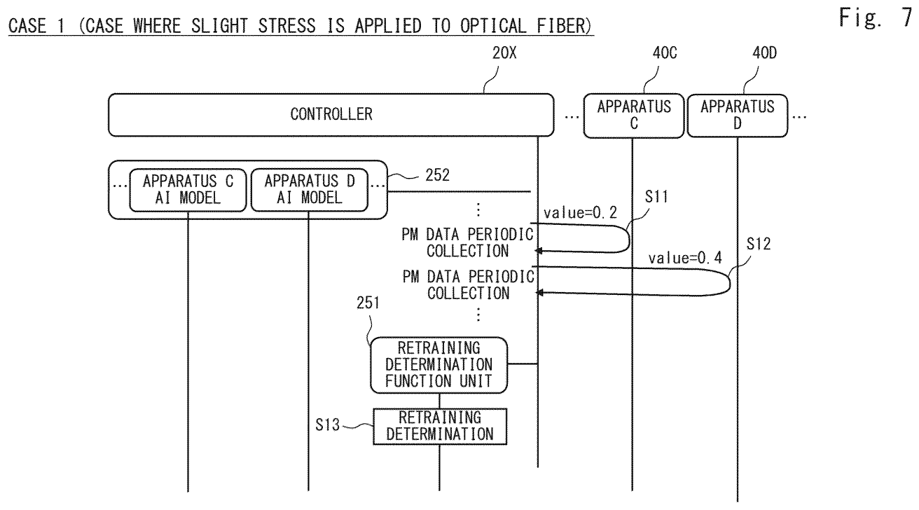

Hereinafter, among the above-described operations performed by the controller 20X after the restoration from the abnormality of the case 1, an operation of determining whether the retraining of the AI model on the OPR side of the optical transmission apparatuses 40B, 40C, 40D, and 40E is necessary is described with reference to FIG. 7.

As illustrated in FIG. 7, the PM management function unit 233 of the controller 20X collects the PM data on the OPR side of the optical transmission apparatuses 40B, 40C, 40D, and 40E at regular timings after the restoration from the abnormality of the case 1. Herein, it is assumed that the value Value of the PM data on the OPR side of the optical transmission apparatus 40C is [0.2±0.1], and the value Value of the PM data on the OPR side of the optical transmission apparatus 40D is [0.4=0.1] (steps S11 and S12).

Next, the retraining determination function unit 251 of the controller 20X determines whether the retraining of the AI model on the OPR side is necessary for each of the optical transmission apparatuses 40B, 40C, 40D, and 40E (step S13).

At this time, the retraining determination function unit 251 of the controller 20X determines whether the retraining of the AI model is necessary by using the mathematical formula 1 and using the value Value of the PM data after the restoration from the abnormality in the case 1 and the average value Av (=0.5) and the allowable error R (=0.3) of the PM data held in the database 26. According to the mathematical formula 1 described above, the threshold range of the value Value of the PM data after the restoration from the abnormality is 0.2≤Value≤0.8.

Herein, the value Value of the PM data on the OPR side of the optical transmission apparatus 40C is [0.2±0.1], the value Value of the PM data on the OPR side of the optical transmission apparatus 40D is [0.4±0.1], and both values are within the above-described threshold range. Therefore, the retraining determination function unit 251 of the controller 20X determines that the retraining is not necessary for the AI model on the OPR side of the optical transmission apparatuses 40C and 40D. Further, although not described, the retraining determination function unit 251 of the controller 20X determines that retraining is not necessary for the AI model on the OPR side of the optical transmission apparatuses 40B and 40E.

As described above, the PM data after the restoration from the abnormality on the OPR side of the optical transmission apparatus 40C varies from the PM data in a normal state, but is within the above-described threshold range. Therefore, it is determined that the AI model on the OPR side of the optical transmission apparatus 40C does not need to be retrained.

### (2) Case 2

Next, the case 2 in which an abnormality that the optical fiber is greatly bent occurs is described.

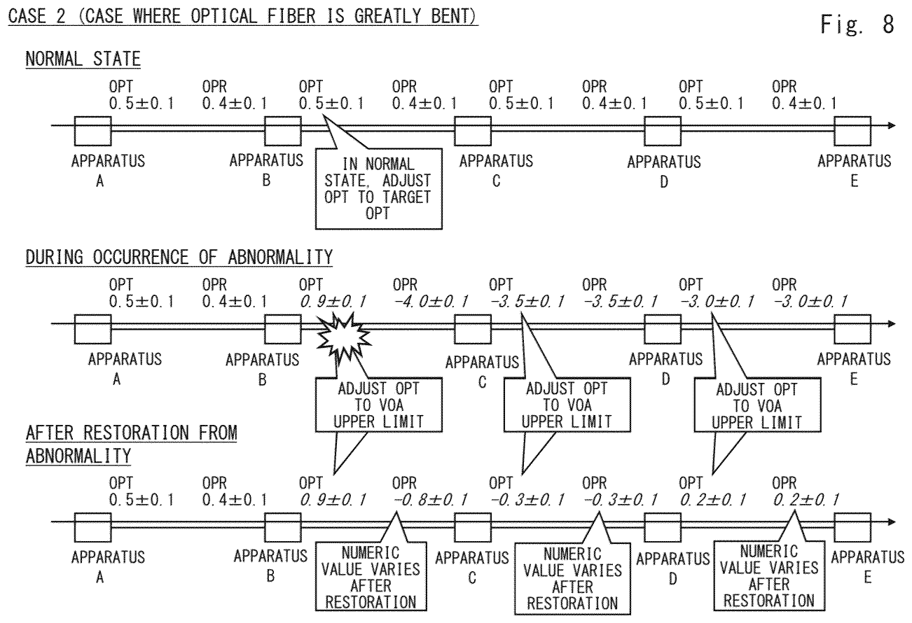

First, with reference to FIG. 8, an example of PM data in a case where an abnormality of the case 2 occurs in the network system 1 is described.

As illustrated in FIG. 8, in a normal state, the optical transmission apparatuses 40A, 40B, 40C, 40D, and 40E adjust the optical power level on the OPT side by using the VOA in such a way as to become the target OPT.

Herein, it is assumed that an abnormality occurs in which the optical fiber between the optical transmission apparatuses 40B and 40C is greatly bent.

During the occurrence of the above-described abnormality, the optical power level on the OPR side of the optical transmission apparatus 40C is greatly reduced to [−4.0±0.1].

Then, the optical transmission apparatus 40B detects the drop in the optical power level on the OPR side of the optical transmission apparatus 40C, and increases the optical power level on the OPT side to the adjustment amount upper limit of the VOA to set [0.9±0.1].

The above-described abnormality also affects the optical transmission apparatuses 40D and 40E in the subsequent stage, and the optical power level on the OPR side of the optical transmission apparatuses 40D and 40E is also lowered.

Therefore, the optical transmission apparatuses 40C and 40D also increase the optical power level on the OPT side to the adjustment amount upper limit of the VOA.

Then, it is assumed that the above-described abnormality has been restored.

At this time, the optical power level after the restoration from the abnormality on the OPR side of the optical transmission apparatus 40C is [−0.8±0.1] and varies from the normal power level [0.4±0.1]. Further, the optical power level after the restoration from the abnormality on the OPR side of the optical transmission apparatus 40D is [−0.3±0.1], and varies from the normal power level [0.4±0.1]. Further, the optical power level after the restoration from the abnormality on the OPR side of the optical transmission apparatus 40E is [0.2±0.1], and varies from the normal power level [0.4±0.1]. On the other hand, the optical power level after the restoration from the abnormality on the OPR side of the other optical transmission apparatus 40B does not vary from the normal power level.

Next, an operation example after the restoration from the abnormality in the case where the abnormality of the case 2 occurs in the network system 1 is described.

The controller 20X determines whether the retraining of the AI model is necessary for each of the OPT side and the OPR side of each of the optical transmission apparatuses 40A, 40B, 40C, 40D, and 40E after the restoration from the abnormality of the case 2.

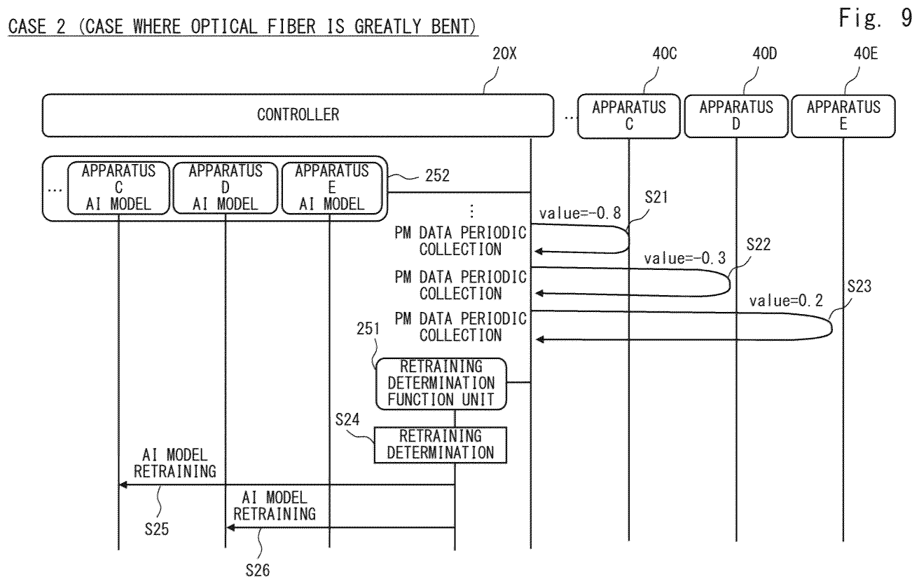

Hereinafter, among the above-described operations performed by the controller 20X after the restoration from the abnormality of the case 2, an operation of determining whether the retraining of the AI model on the OPR side of the optical transmission apparatuses 40B, 40C, 40D, and 40E is necessary is described with reference to FIG. 9.

As illustrated in FIG. 9, the PM management function unit 233 of the controller 20X collects the PM data on the OPR side of the optical transmission apparatuses 40B, 40C, 40D, and 40E at regular timings after the restoration from the abnormality of the case 2. Herein, it is assumed that the value Value of the PM data on the OPR side of the optical transmission apparatus 40C is [−0.8±0.1], the value Value of the PM data on the OPR side of the optical transmission apparatus 40D is [-0.3+0.1], and the value Value of the PM data on the OPR side of the optical transmission apparatus 40E is [0.2+0.1] (steps S21 to S23).

Next, the retraining determination function unit 251 of the controller 20X determines whether the retraining of the AI model on the OPR side is necessary for each of the optical transmission apparatuses 40B, 40C, 40D, and 40E (step S24).

At this time, the retraining determination function unit 251 of the controller 20X determines whether the retraining of the AI model is necessary by using the mathematical formula 1 and using the value Value of the PM data after the restoration from the abnormality in the case 2 and the average value Av (=0.5) and the allowable error R (=0.3) of the PM data held in the database 26. According to the mathematical formula 1 described above, the threshold range of the value Value of the PM data after the restoration from the abnormality is 0.2≤Value≤0.8.

Herein, the value Value of the PM data on the OPR side of the optical transmission apparatus 40C is [−0.8±0.1], the value Value of the PM data on the OPR side of the optical transmission apparatus 40D is [−0.3±0.1], and both of the values are outside the above-described threshold range. Therefore, the retraining determination function unit 251 of the controller 20X determines that the AI model on the OPR side of the optical transmission apparatuses 40C and 40D requires retraining. On the other hand, the value Value of the PM data on the OPR side of the optical transmission apparatus 40E is [0.2±0.1], and is within the above-described threshold range. Therefore, the retraining determination function unit 251 of the controller 20X determines that the retraining is not necessary for the AI model on the OPR side of the optical transmission apparatus 40E. Further, although not described, the retraining determination function unit 251 of the controller 20X determines that the retraining is not necessary for the AI model on the OPR side of the optical transmission apparatus 40B.

As described above, the PM data after the restoration from the abnormality on the OPR side of the optical transmission apparatus 40E varies from the PM data in the normal state, but is within the above-described threshold range. Therefore, it is determined that the AI model on the OPR side of the optical transmission apparatus 40E does not need to be retrained.

Thereafter, the retraining determination function unit 251 of the controller 20X instructs the AI function unit 252 of the controller 20X to retrain the AI model on the OPR side of the optical transmission apparatuses 40C and 40D (steps S25 and S26).

As described above, according to the first example embodiment, the controller 20 holds the average value and the allowable error of the PM data on the OPR side or the OPT side of the optical transmission apparatus 40 for each of the OPR side and the OPT side of each of the optical transmission apparatuses 40 provided in the connected optical transmission network 30. Then, in a case where there is an optical transmission apparatus 40 in which the PM data on the OPR side or the OPT side after the restoration from the abnormality is outside the threshold range, which is derived from the average value and the allowable error, the controller 20 determines that retraining is necessary for the AI model on the OPR side or the OPT side of the relevant optical transmission apparatus 40.

Therefore, even if a slight variation occurs in the PM data after the restoration from the abnormality, as long as the PM data falls within the range of the threshold range, the retraining of the AI model is unnecessary. As a result, the number of AI models to be retrained is reduced, and therefore the retraining cost of the AI model can be reduced. Further, since the number of AI models to be retrained is reduced, it is also possible to contribute to reduction in the load of computing resources, stabilization of the AI model, and automation of operation and maintenance work of the network.

### Second Example Embodiment

The second example embodiment is equivalent to an example embodiment being a generic concept of the first example embodiment described above.

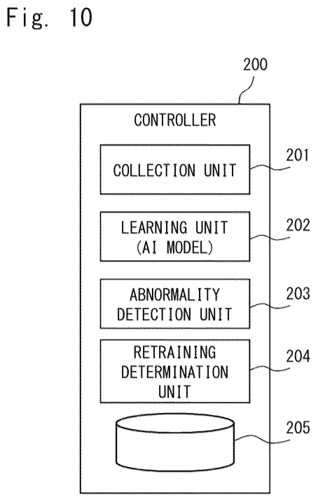

A configuration example of a controller 200 is described with reference to FIG. 10.

As illustrated in FIG. 10, the controller 200 includes a collection unit 201, a learning unit 202, an abnormality detection unit 203, a retraining determination unit 204, and a database 205.

The collection unit 201 collects performance monitoring (PM) data representing an optical power level of an optical signal of each of a plurality of optical transmission apparatuses provided in an optical transmission network.

The learning unit 202 is provided for each of the plurality of optical transmission apparatuses, and includes a plurality of artificial intelligence (AI) models that learn time-series variation of PM data of the optical transmission apparatus by using PM data of the relevant optical transmission apparatus as learning data.

The database 205 holds an average value and an allowable error of PM data of the optical transmission apparatus for each of the plurality of optical transmission apparatuses.

The abnormality detection unit 203 detects an abnormality within the optical transmission network by using the plurality of AI models.

The retraining determination unit 204 determines that, in a case where there is an optical transmission apparatus in which the PM data after the restoration from the abnormality is outside the threshold range, which is derived from an average value and an allowable error, retraining of the AI model of the relevant optical transmission apparatus is necessary.

As described above, according to the second example embodiment, the controller 200 holds the average value and the allowable error of the PM data of the optical transmission apparatus for each of the plurality of optical transmission apparatuses. Then, in a case where there is an optical transmission apparatus in which the PM data after the restoration from the abnormality is outside the threshold range, which is derived from the average value and the allowable error, the controller 200 determines that the retraining of the AI model of the relevant optical transmission apparatus is necessary.

Therefore, even if a slight variation occurs in the PM data after the restoration from the abnormality, as long as the PM data falls within the range of the threshold range, the retraining of the AI model is unnecessary. As a result, the number of AI models to be retrained is reduced, and therefore the retraining cost of the AI models can be reduced.

Note that the collection unit 201 may collect PM data at a reception end (equivalent to the above-described OPR) and a transmission end (equivalent to the above-described OPT) of each of the plurality of optical transmission apparatuses. Further, the plurality of AI models may be provided for each of the reception end and the transmission end of each of the plurality of optical transmission apparatuses, and may learn time-series variation of the PM data of the reception end or the transmission end of the relevant optical transmission apparatus. Further, the database 205 may hold the average value and the allowable error of the PM data of the reception end or the transmission end of the optical transmission apparatus for each of the reception end and the transmission end of each of the plurality of optical transmission apparatuses. Further, in a case where there is an optical transmission apparatus in which the PM data of the reception end or the transmission end after the restoration from the abnormality is outside the threshold range, the retraining determination unit 204 may determine that the retraining of the AI model of the reception end or the transmission end of the relevant optical transmission apparatus is necessary.

Further, the retraining determination unit 204 may instruct the AI model of the optical transmission apparatus that has been determined that the retraining is necessary, to perform the retraining.

Further, the retraining determination unit 204 may determine that the retraining of an AI model of an optical transmission apparatus is unnecessary for an optical transmission apparatus in which the PM data after the restoration from the abnormality is within the threshold range.

The threshold range may be a range in which a value acquired by adding the allowable error to the average value is set as an upper limit and a value acquired by subtracting the allowable error from the average value is set as a lower limit.

Further, the collection unit 201 may periodically collect PM data of each of the plurality of optical transmission apparatuses.

The abnormality in the optical transmission network may be an abnormality of a physical port of any of the plurality of optical transmission apparatuses. Alternatively, the abnormality in the optical transmission network may be an abnormality of an optical fiber between the plurality of optical transmission apparatuses.

### <Hardware Configuration of Controller According to Example Embodiments>

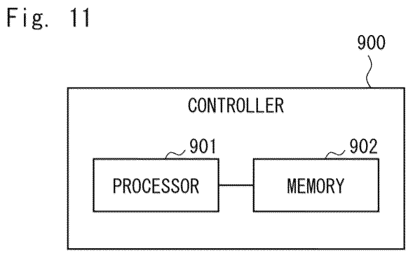

A hardware configuration example of a computer 900 that implements the above-described controllers 20 and 200 is described with reference to FIG. 11. As illustrated in FIG. 11, the computer 900 includes a processor 901 and a memory 902. The processor 901 and the memory 902 are coupled to each other.

The processor 901 may be, for example, a microprocessor, a micro processing unit (MPU), or a central processing unit (CPU). The processor 901 may include a plurality of processors.

The memory 902 is configured of a combination of a volatile memory and a non-volatile memory. The memory 902 may include storage located separately from the processor 901. In such a case, the processor 901 may access the memory 902 via an input (I)/output (o) interface (not illustrated).

The memory 902 may store a software module (computer program) including instructions and data for performing processing of the controllers 20 and 200 described above.

Also, in some implementations, the processor 901 may be configured to read and execute software modules from the memory 902 and thereby perform the processing of the controllers 20 and 200 described above.

Further, the program can be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Further, each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

Further, the whole or part of the example embodiments disclosed above can be described as, but not limited to, the following supplementary notes.

### (Supplementary Note 1)

A controller including:
at least one memory storing instructions;
a first processor configured to execute the instructions and collect performance monitoring (PM) data representing an optical power level of an optical signal of each of a plurality of optical transmission apparatuses provided in an optical transmission network;
a plurality of artificial intelligence (AI) models, being provided for each of the plurality of optical transmission apparatuses provided in the optical transmission network, configured to learn a variation in time series of the PM data of the optical transmission apparatus by using the PM data of the optical transmission apparatus as learning data;
a database configured to hold an average value and an allowable error of the PM data of the optical transmission apparatus for each of the plurality of optical transmission apparatuses;
a second processor configured to execute the instructions and detect an abnormality within the optical transmission network by using the plurality of AI models; and
a third processor configured to execute the instructions and, in a case where there is an optical transmission apparatus in which the PM data after restoration from the abnormality are outside a threshold range, which is derived from the average value and the allowable error, determine that an AI model of the relevant optical transmission apparatus needs retraining.

### (Supplementary Note 2)

The controller according to supplementary note 1, wherein
the first processor is further configured to execute the instructions and collect the PM data in a reception end and a transmission end of each of the plurality of optical transmission apparatuses,
the plurality of AI models are provided for each of a reception end and a transmission end of each of the plurality of optical transmission apparatuses, and learn a variation in time series of the PM data of the reception end or the transmission end of the optical transmission apparatus,
the database holds the average value and the allowable error of the PM data of the reception end or the transmission end of the optical transmission apparatus for each of the reception end and the transmission end of each of the plurality of optical transmission apparatuses, and
the third processor is further configured to execute the instructions, and, in a case where there is an optical transmission apparatus in which the PM data of the reception end or the transmission end after restoration from the abnormality are outside the threshold range, determine that an AI model of the reception end or the transmission end of the relevant optical transmission apparatus needs retraining.

### (Supplementary Note 3)

The controller according to supplementary note 1, wherein the third processor is further configured to execute the instructions and instruct retraining on an AI model of a relevant optical transmission apparatus that has been determined that retraining is necessary.

### (Supplementary Note 4)

The controller according to supplementary note 1, wherein the third processor is further configured to execute the instructions and determine that retraining on an AI model of an optical transmission apparatus is unnecessary for the optical transmission apparatus in which the PM data after restoration from an abnormality is within the threshold range.

### (Supplementary Note 5)

The controller according to supplementary note 1, wherein the threshold range is a range in which a value acquired by adding the allowable error to the average value is set as an upper limit, and a value acquired by subtracting the allowable error from the average value is set as a lower limit.

(Supplementary note 6)

The controller according to supplementary note 1, wherein the first processor is further configured to execute the instructions and periodically collect the PM data of each of the plurality of optical transmission apparatuses.

(Supplementary note 7)

The controller according to supplementary note 1, wherein the abnormality in the optical transmission network is an abnormality in a physical port of one of the plurality of optical transmission apparatuses.

(Supplementary note 8)

The controller according to supplementary note 1, wherein the abnormality in the optical transmission network is an abnormality in an optical fiber between the plurality of optical transmission apparatuses.

(Supplementary note 9)

A training cost reduction method to be executed by a controller, the method including:
collecting performance monitoring (PM) data representing an optical power level of an optical signal of each of a plurality of optical transmission apparatuses provided in an optical transmission network;
learning, with a plurality of artificial intelligence (AI) models provided for each of the plurality of optical transmission apparatuses, a variation in time series of the PM data of the optical transmission apparatus by using the PM data of the optical transmission apparatus as learning data;
storing an average value and an allowable error of the PM data of the optical transmission apparatus in a database for each of the plurality of optical transmission apparatuses;
detecting an abnormality within the optical transmission network by using the plurality of AI models; and,
in a case where there is an optical transmission apparatus in which the PM data after restoration from the abnormality are outside a threshold range, which is derived from the average value and the allowable error, determining that an AI model of the relevant optical transmission apparatus needs retraining.
   (Supplementary note 10)

A non-transitory computer-readable medium storing a program causing a computer to execute:
a procedure of collecting performance monitoring (PM) data representing an optical power level of an optical signal of each of a plurality of optical transmission apparatuses provided in an optical transmission network;
a procedure of learning, with a plurality of artificial intelligence (AI) models provided for each of the plurality of optical transmission apparatuses, a variation in time series of the PM data of the optical transmission apparatus by using the PM data of the optical transmission apparatus as learning data;
a procedure of storing an average value and an allowable error of the PM data of the optical transmission apparatus in a database for each of the plurality of optical transmission apparatuses;
a procedure of detecting an abnormality within the optical transmission network by using the plurality of AI models; and
a process of, in a case where there is an optical transmission apparatus in which the PM data after restoration from the abnormality are outside a threshold range, which is derived from the average value and the allowable error, determining that an AI model of the relevant optical transmission apparatus needs retraining.

Note that, some or all of elements (e.g., structures and functions) specified in Supplementary Notes 2 to 8 dependent on Supplementary Note 1 may also be dependent on Supplementary Note 9 and Supplementary Note 10 in dependency similar to that of Supplementary Notes 2 to 8 dependent on Supplementary Note 1. Some or all of elements specified in any of Supplementary Notes may be applied to various types of hardware, software, and recording means for recording software, systems, and methods.

According to the above-described aspect, it is possible to provide a controller, a training cost reduction method, and a non-transitory computer-readable medium that are capable of reducing the retraining cost of an AI model after restoration from an abnormality.

What is claimed is:

1. A controller comprising:
at least one memory storing instructions;
a first processor configured to execute the instructions and collect performance monitoring (PM) data representing an optical power level of an optical signal of each of a plurality of optical transmission apparatuses provided in an optical transmission network;
a plurality of artificial intelligence (AI) models, being provided for each of the plurality of optical transmission apparatuses provided in the optical transmission network, configured to learn a variation in time series of the PM data of the optical transmission apparatus by using the PM data of the optical transmission apparatus as learning data;
a database configured to hold an average value and an allowable error of the PM data of the optical transmission apparatus for each of the plurality of optical transmission apparatuses;
a second processor configured to execute the instructions and detect an abnormality within the optical transmission network by using the plurality of AI models; and
a third processor configured to execute the instructions and, in a case where there is an optical transmission apparatus in which the PM data after restoration from the abnormality are outside a threshold range, which is derived from the average value and the allowable error, determine that an AI model of the relevant optical transmission apparatus needs retraining.

2. The controller according to claim 1, wherein
the first processor is further configured to execute the instructions and collect the PM data in a reception end and a transmission end of each of the plurality of optical transmission apparatuses,
the plurality of AI models are provided for each of a reception end and a transmission end of each of the plurality of optical transmission apparatuses, and learn a variation in time series of the PM data of the reception end or the transmission end of the optical transmission apparatus,
the database holds the average value and the allowable error of the PM data of the reception end or the transmission end of the optical transmission apparatus for each of the reception end and the transmission end of each of the plurality of optical transmission apparatuses, and
the third processor is further configured to execute the instructions, and, in a case where there is an optical transmission apparatus in which the PM data of the reception end or the transmission end after restoration from the abnormality are outside the threshold range, determine that an AI model of the reception end or the transmission end of the relevant optical transmission apparatus needs retraining.

3. The controller according to claim 1, wherein the third processor is further configured to execute the instructions and instruct retraining on an AI model of a relevant optical transmission apparatus that has been determined that retraining is necessary.

4. The controller according to claim 1, wherein the third processor is further configured to execute the instructions and determine that retraining on an AI model of an optical transmission apparatus is unnecessary for the optical transmission apparatus in which the PM data after restoration from an abnormality is within the threshold range.

5. The controller according to claim 1, wherein the threshold range is a range in which a value acquired by adding the allowable error to the average value is set as an upper limit, and a value acquired by subtracting the allowable error from the average value is set as a lower limit.

6. The controller according to claim 1, wherein the first processor is further configured to execute the instructions and periodically collect the PM data of each of the plurality of optical transmission apparatuses.

7. The controller according to claim 1, wherein the abnormality in the optical transmission network is an abnormality in a physical port of any of the plurality of optical transmission apparatuses.

8. The controller according to claim 1, wherein the abnormality in the optical transmission network is an abnormality in an optical fiber between the plurality of optical transmission apparatuses.

9. A training cost reduction method to be executed by a controller, the method comprising:
collecting performance monitoring (PM) data representing an optical power level of an optical signal of each of a plurality of optical transmission apparatuses provided in an optical transmission network;
learning, with a plurality of artificial intelligence (AI) models provided for each of the plurality of optical transmission apparatuses, a variation in time series of the PM data of the optical transmission apparatus by using the PM data of the optical transmission apparatus as learning data;
storing an average value and an allowable error of the PM data of the optical transmission apparatus in a database for each of the plurality of optical transmission apparatuses;
detecting an abnormality within the optical transmission network by using the plurality of AI models; and,
in a case where there is an optical transmission apparatus in which the PM data after restoration from the abnormality are outside a threshold range, which is derived from the average value and the allowable error, determining that an AI model of the relevant optical transmission apparatus needs retraining.

10. A non-transitory computer-readable medium storing a program causing a computer to execute:
a procedure of collecting performance monitoring (PM) data representing an optical power level of an optical signal of each of a plurality of optical transmission apparatuses provided in an optical transmission network;
a procedure of learning, with a plurality of artificial intelligence (AI) models provided for each of the plurality of optical transmission apparatuses, a variation in time series of the PM data of the optical transmission apparatus by using the PM data of the optical transmission apparatus as learning data;
a procedure of storing an average value and an allowable error of the PM data of the optical transmission apparatus in a database for each of the plurality of optical transmission apparatuses;
a procedure of detecting an abnormality within the optical transmission network by using the plurality of AI models; and
a procedure of, in a case where there is an optical transmission apparatus in which the PM data after restoration from the abnormality are outside a threshold range, which is derived from the average value and the allowable error, determining that an AI model of the relevant optical transmission apparatus needs retraining.
